(19) United States
(12) Patent Application Publication
(10) Pub. No.: US 2004/0181688 A1
(43) Pub. Date: Sep. 16, 2004

(54) Systems and methods for the copy-protected distribution of electronic documents

(75) Inventor: Erland Wittkotter, Bunde (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BrainShield Technologies, Inc.

(21) Appl. No.: 10/635,798

(22) Filed: Aug. 5, 2003

(30) Foreign Application Priority Data
Aug. 6, 2002 (DE) DE 10236061.8

(51) Int. Cl. H04L 9/00

(52) U.S. Cl. 713/201

(57) ABSTRACT

A peer-to-peer system for distributing electronic documents in which each peer computer is configured for receiving operating sequence command data, and for accessing an electronic document over a network by downloading, via at least two separate downloads, a plurality of data segments that are associated with an electronic document and that represent an encrypted form of the document. The document is encrypted by the effect of the operating sequence command data determining the order of the data segments, and the data segments are not usable by a user as downloaded. At least one of the downloads is from the second computer and at least one of the downloads is from a third computer. The system is further configured for accessing reconstruction data over the network and for using the reconstruction data and the encrypted form of the document to make the document available for use in a suitable decrypted form.

### CROSS-REFERENCE TO RELATED APPLICATIONS

This application claims the benefit of German Patent Application 102 36 061.8, entitled “Vorrichtung zum kopiergeschützten Verteilen elecktronischer Dokumente”, which was filed on Aug. 6, 2002, and which is hereby incorporated herein by reference.

### BACKGROUND OF THE INVENTION

German patent application DE 199 50 267 and international patent application PCT/EP00/06824 (WO01/06341), which are both hereby incorporated by reference, describe a centralized, server-based system for distributing electronic documents (such as text, video, multimedia and music documents) over a computer network (such as the Internet). Although the techniques taught in this patent are useful and viable in commercial applications, the use of a server as a central distribution medium may be problematic in the future in view of the fact that the average size of documents transferred over public computer networks, such as the Internet, is increasing rapidly.

Another significant technological development that is related to the transfer of electronic documents over networks is the development of peer-to-peer networks, such as Napster. Systems designed according to the Napster principle typically include a central server that receives information from associated peer computers (clients) and that indicates which sets of data (e.g., MP3 files) are available for download from the various peer computers within the network. The users of the various peer computers are then permitted to search this information for particular data (e.g., a particular MP3 file) that they wish to download. After finding a desired file, the user may then establish immediate contact with the owner of the file and download the file from the owner within the framework of the peer-to-peer network. The Napster system is based on an exchange principle where every user who has the ability to download files from the various peer computers within the network is also expected to make data available for downloading by other users within the network.

Even aside from the potential copyright issues associated with the Napster system (the Napster technology was strongly criticized in the US and has resulted in legal consequences for the operators), the server-focused structure of the Napster system is undesirable for several reasons. First, a failure of the central server would paralyze the entire network. In addition, minor transmission problems during a direct data exchange often make it necessary for users to repeat the exchange completely. This is due to the fact that the Napster system only allows a complete set of data (e.g., a file) to be identified by name. The Napster system is also vulnerable to attacks with wrongly-identified content or from computer viruses.

In spite of its disadvantages, the Napster system has proven to be efficient in facilitating the distribution of electronic data. This may be due, in part, to the system's ability to allow users to identify and download specified files from a multitude of connected peer computers.

Numerous other electronic document distribution systems are also currently in use. An example of such a system is the “Gnutella” system, which is a peer-to-peer system like Napster (since respective participants exchange electronic content directly between themselves). However, in contrast to the Napster system, which features server-centralized control during searching for desired electronic documents, Gnutella is a decentralized peer-to-peer system. In such decentralized peer-to-peer systems, a query of a first peer computer (searcher) for a particular file is not transmitted over a central title server. Rather, a plurality of peer computers are directly searched in the form of a multi-step, fanned cascade. This search ends with the discovery of the desired data on another (second) peer computer. Once the data is located, direct contact is established between the first and second peer computers and the data is downloaded from the second computer to the first computer.

One advantage of the Gnutella system is that it is not as easily affected by errors as the Napster system because the Gnutella system does not depend on a single server for distributing information related to available data. However, the cascading search techniques used by the Gnutella system are inefficient and, thus, place higher demands on the resources of the peer computers within the network. Also, like Napster, the Gnutella system is susceptible to computer viruses that are transmitted to third parties under the title of an electronic document (such as an MP3 file).

Thus, in light of the above, there is a need for improved systems and methods of distributing copyright-protected documents.

### SUMMARY OF THE INVENTION

A system for distributing electronic documents according to one embodiment of the invention comprises: (1) a first computer; (2) a second computer; (3) a third computer; and (4) a network over which information may be transferred from the second and third computers to the first computer. In this embodiment of the invention, the first computer is configured for receiving operating sequence command data and accessing an electronic document over the network by downloading, via at least two separate downloads, a plurality of data segments that are associated with an electronic document and that represent an encrypted form of the electronic document. In this embodiment of the invention, at least one of the downloads is from the second computer and at least one of the downloads is from the third computer. In addition, the electronic document is encrypted by the effect of the operating sequence command data determining the order of the plurality of data segments, which are not usable by a user as downloaded. The first computer is further configured for accessing reconstruction data over the network, and using the reconstruction data and the encrypted form of the electronic document to make the electronic document available for use in a suitable decrypted form.

A peer-to-peer system for distributing electronic documents according to one embodiment of the invention comprises a first peer computer, and a network over which information may be transferred from the first peer computer to a second peer computer. In this embodiment of the invention, the first peer computer is configured for: (1) dividing an electronic document into a plurality of data segments; (2) producing an encrypted form of the electronic document that is encrypted via an arrangement of the data segments, the arrangement being determined by a set of operating sequence command data; (3) transmitting the plurality of data segments to the second peer computer; and (4) generating a set of data that is useable for generating the set of operating sequence command data.

A method of distributing electronic documents according to one embodiment of the invention comprises the steps of: (1) receiving a request for an electronic document from a first peer computer connected to a network; (2) identifying a plurality of data network addresses, each of the plurality of data network addresses corresponding to a location of at least one of a plurality of data segments associated with the electronic document, the plurality of data segments being stored, in a distributed manner, on a plurality of peer computers; (3) providing an operating sequence command set that comprises the plurality of data network addresses; and (4) transmitting the operating sequence command set to the first peer computer so that the first peer computer may use the operating sequence command set to access at least one of the plurality of data segments.

A method of distributing electronic documents according to yet another embodiment of the invention comprises the steps of: (1) receiving operating sequence command data; (2) accessing an electronic document over a network by downloading, via one or more downloads from each of a plurality of computers, a plurality of data segments that are associated with an electronic document and that represent an encrypted form of the electronic document, the electronic document being encrypted by the effect of the operating sequence command data determining their order, and the plurality of data segments not being usable by a user as downloaded; (3) accessing reconstruction data over the network; and (4) using the reconstruction data and the encrypted form of the electronic document to make the electronic document available for use in a suitable decrypted form.

A system for distributing electronic documents within a peer to peer network according to a further embodiment of the invention comprises a first peer computer, a second peer computer, and a data server unit. In this embodiment of the invention, the first peer computer is configured for dividing an electronic document into two or more data segments that are associated with at least one correct playback sequence. Furthermore, the data server unit is configured for generating an encryption sequence for the two or more data segments, the encryption sequence being different than the correct playback sequence. In addition, the second peer computer is configured for: (a) receiving at least one of the data segments from the first computer, and (b) storing the at least one data segment in a file that corresponds to an encrypted form of the electronic document in which the data segments that comprise the electronic document are stored in the encryption sequence.

A system for distribution of electronic documents of a predetermined document data structure in a publicly accessible electronic data network according to yet another embodiment of the invention comprises a plurality of participant units that are connected to the electronic data network at least part of the time, each of the participant units being associated with a user and being constructed for executing a download of an electronic document by a participant unit or a server unit connected to the data network as well as for opening the electronic document by means of a playback unit. In this embodiment of the invention: (1) the participant units are constructed for accessing the electronic document over the publicly accessible electronic data network in such a way that multiple downloads of a plurality of associated data segments are executed, where at least one download is done by another participant unit that is associated with another user; (2) the participant units receive document- and/or participant-specific operating sequence command data from a command data unit connected to the electronic data network; (3) the plurality of electronic data segments are available to the participant through a plurality of downloads, are associated with the electronic document, and represent the form of the electronic document, the electronic document being encrypted by the effect of the operating sequence command data determining the order of the electronic data segments, which are not usable by the user in the way provided; (4) a reconstruction unit is connected to the electronic data network, the reconstruction unit being configured for storing reconstruction data related to an electronic document in an encrypted form; and (5) each of the participant units comprises a local decryption unit that is designed for at least one access to the reconstruction unit for each electronic document over the electronic data network and to bring together the encrypted form for making the electronic document available for use in a suitable decrypted form.

A system for distribution of electronic documents of a predetermined data structure in a publicly accessible electronic data network according to another embodiment of the invention comprises a plurality of participant units connected to the electronic data network at least part of the time. In this embodiment of the invention, each of the participant units is associated with a user, configured for executing a download of an electronic document from a participant unit connected to the electronic data network or from a server unit, and configured for opening the electronic document by means of a user-side playback unit. Furthermore, in this embodiment of the invention, each of the participant units comprises a publication unit that is configured for: (1) dividing the electronic document into a plurality of data segments; (2) producing a distributable version of the electronic document, the distributable version being encrypted via the arrangement of the data segments, and the arrangement of data segments being determined by operating sequence command data; (3) transmitting the plurality of electronic data segments to at least one other participant unit; and (4) recording document-specific data on a document name unit that is connected to the electronic data network and that comprises a data server unit that is connected to the electronic data network and that is configured for storing data about one or more data segments stored on at least one other participant unit, the data being used to generate operating sequence commands.

A method of distributing copyright-protected electronic documents of a predetermined document data structure in a publicly accessible electronic data network according to yet another embodiment of the invention comprises the steps of: (1) receiving an inquiry for an electronic document from a participant unit connected to the electronic data network; (2) identifying a plurality of data net addresses that correspond to the storage locations of a plurality of data segments that are associated with the electronic document, the data segments being stored on a plurality of participant units in a distributed manner; (3) providing an operating sequence command set that contains the data network addresses in a predetermined sequence; (4) transmitting the operating sequence command set to the participant unit; and (5) using the operating sequence command set to access the plurality of data segments for purposes of storing the plurality of data segments in the predetermined sequence.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for distribution of electronic documents according to one embodiment of the invention.

FIG. 2 is a block diagram of a system for distribution of electronic documents according to another embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

A system according to one embodiment of the invention is configured for distributing electronic documents over an electronic data network. In a particular embodiment of the invention, the system is configured for distributing documents between various participants in a peer-to-peer network of computers. A “participant” (or “participant unit”) as used in this disclosure refers to a computer or other processing device that is typically, but not necessarily, associated with a user, and that is configured for executing common upload/download tasks over a network, such as the Internet. Participants are preferably independent of other participant units and are preferably configured for uploading data from, and downloading data to, those other participant units.

In one embodiment of the invention, the system comprises a peer-to-peer system that is configured for dividing electronic documents (such as music files, video files, computer programs, or text files) into a plurality of data segments. For example, in the case of MP3 files, this division process typically involves dividing the MP3 files into respective MP3 frames, which are defined according to the MP3 document format standard.

In one embodiment of the invention, the plurality of data segments that make up a particular electronic document are deposited on at least one participant unit other than the searching participant unit (the participant unit that is seeking to access the electronic document) so that the electronic document is not present in its original form on any particular participant unit. In other words, the electronic document is preferably only present in an encrypted form in which the data segments that make up the electronic document are in an arrangement that is different than their original form.

In order for a searching participant unit to access a desired electronic document, the searching participant unit receives a sequence of electronic processing commands from an operating sequence command data unit. In one embodiment of the invention, this sequence of electronic processing commands provides a pre-determined sequence of data segments (that is typically associated with the searching participant unit). In addition, this sequence of electronic processing commands may provide a storage location (address) for each of the respective data segments. These storage locations may be associated with one or more participant units other than the searching participant unit.

By executing the electronic operating sequence command data, the searching participant unit may access a plurality of electronic data segments that are associated with (and typically make up) the desired electronic document. However, as noted above, these electronic data segments are typically available to the searching participant unit in an encrypted form in which the data segments are not useful to the participant unit for the data segments' intended purpose.

In one embodiment of the invention, in order to reproduce the electronic document for the user in the electronic document's original, non-encrypted form (e.g., so that the electronic document is “suitable for use”), it is necessary to first contact a reconstruction unit. This reconstruction unit is typically a server unit that is connected to the electronic data network (e.g., the Internet, a LAN, or any other suitable network), and that is configured to make an appropriate set of reconstruction data available to a searching participant unit in response to receiving a corresponding request from the searching participant unit. In various embodiments of the invention, the reconstruction unit is configured to only make an appropriate set of reconstruction data available to the searching participant unit after: (1) confirming that the searching participant unit is authorized to access the reconstruction data; (2) confirming that a user associated with the searching participant unit has paid for access to the reconstruction data; and/or (3) executing a commercial transaction (e.g., in which a user associated with the searching participant unit is charged a fee for accessing the reconstruction data).

In one embodiment of the invention, the reconstruction data allows the searching participant unit to produce a desired “usable” (e.g., non-encrypted) form of the electronic document. In a particular embodiment of the invention, the reconstruction data comprises a set of index data (also referred to as “sequence data”) that is useable to decrypt the plurality of the data segments into a useable form.

In one embodiment of the invention, one or more of the participant units in a peer-to-peer network is configured both for downloading data segments from other participant units and for downloading data segments to other participant units within the peer-to-peer network. This provides for additional efficiencies that are not found in traditional client-server data distribution arrangements. In addition, as discussed in greater detail below, other aspects of the invention (such as the use of operating sequence command data) serve, in various embodiments of the invention, to provide a system that prevents users from freely distributing electronic documents.

As noted above, in one embodiment of the invention, the system is configured so that a particular electronic document is never available in a totally decrypted form at a target (e.g., searching) participant unit. Rather, the document is stored in an encrypted format, and preferably in a “semantically encrypted format”. As discussed in German patent application DE 199 50 267 and international patent application PCT/EP00/06824 (WO01/06341), which are both hereby incorporated by reference, semantic encryption techniques involve encrypting an electronic document by, for example, exchanging, removing, adding and/or substituting one or more data segments from within an electronic document.

In one embodiment of the invention, the system is configured for preventing a participant unit from reconstructing an electronic document downloaded in the peer-to-peer network in the manner described above until the participant unit has provided access information such as an account number, a credit card number, or other suitable information. In one embodiment of the invention, the system is configured for providing data from a reconstruction unit in response to receiving this access information. This data is preferably useable to allow the participant to use the downloaded data segments to use (e.g., play, read, or execute) a corresponding electronic document.

In one embodiment of the invention, one or more of the participant units within a peer-to-peer network are configured for publishing electronic documents over the peer-to-peer network in a copy-protected manner by dividing one or more electronic documents (e.g., unencrypted electronic documents) into a plurality of data segments and then using semantic encryption techniques to encrypt the documents.

More particularly, in one embodiment of the invention, before publishing a document, a participant unit identifies the format structure of the electronic document to be encrypted, and then divides the electronic document into a plurality of data segments (which may be usable independently from each other). Such data segments may be, for example: (1) one or more frames of an MP3 or video file; (2) sentences, words, or paragraphs from a text file; or (3) one or more individual pixels or groups of pixels from a bitmap file.

In one embodiment of the invention, after dividing the electronic document into a plurality of data segments, the participant unit (or other computer) arranges the individual data segments into an encrypted format. In a particular embodiment of the invention, the document is encrypted based on the sequence of the individual data segments, which preferably does not correspond to the sequence of the individual data segments in an unencrypted form of the electronic document. This arrangement of the individual data segments is preferably used to determine a set of operating sequence command data for downloading the document in the peer-to-peer system.

In a particular embodiment of the invention, the participant unit is configured for publishing an electronic document by depositing one or more of the data segments that comprise the electronic document on one or more other participant units. The participant unit is also preferably configured for making “document identifying data”, that is associated with the electronic document, available to one or more participant units within the peer-to-peer network. In one embodiment of the invention, the participant unit is configured for making this document identifying data available to a central “document name unit”. The document identification data may be, for example, the title of the electronic document.

In one embodiment of the invention, the data segments that make up an encrypted form of an electronic document are organized in a hierarchy of data segments. This hierarchy comprises a first group of data segments that are downloaded to one or more participant units. In one embodiment of the invention, this downloading process is controlled by operating sequence command data as described herein.

A second group of data segments may be embedded within the first group of data segments (ideally in a 1:n ratio). This second group of data segments is preferably semantically encrypted (or encrypted in another manner) as discussed in German patent DE 199 50 267. This second group of data segments may preferably be decrypted by means of reconstruction data as discussed elsewhere in this application (where the reconstruction data typically provide for a correct pre-determined arrangement of the second data segments for reproduction according to the pre-determined arrangement). In this way, it is possible to drastically reduce the number of instructions that are necessary for the creation of the operating sequence command data (e.g., in the form of download scripts).

In addition, it is possible to execute the reconstruction of the first data segments, subordinated in the hierarchy, with independent reconstruction instructions, which can be present statically or preferably can be created dynamically and individually during download of the respective first data segments.

In one embodiment of the invention, a command data unit is configured to allow a single participant unit to simultaneously access streamed data from a plurality of other participant units within a peer-to-peer network. In this embodiment, the reconstruction data is preferably configured to enable a participant to view streamed data (although, in some embodiments of the invention, there will be a time lapse between the time that the data is transmitted from the source participant units to the target recipient unit. In one embodiment of the invention, the participant units, which are preferably connected to have high-speed access to the Internet (e.g., via a T1 Line, DSL, or a cable modem) are technically configured to simultaneously send and receive information. This aspect of the participant units facilitates the transfer of streamed data between participant units as coordinated by the command data unit.

As will be understood by one skilled in the art, the usable receiving (downstream) bandwidth of a computer (such as a participant unit) is often is several times larger than the corresponding sending (upstream) bandwidth of the computer. As a result, it is possible within the framework of the invention, for a single recipient participant unit to receive simultaneous downloads from a plurality of (e.g., small bandwidth) transmitting participant units, where individual data segments transmitted via the plurality of downloads are used to reproduce a single stream of data on the recipient computer. For example, the recipient computer may receive these individual data segments from the recipient computer in an alternating manner from the plurality of connected participant units. Accordingly, a system according to one embodiment of the invention is configured for using the asymmetrical upload/download characteristics of various participant units in conjunction with the command data unit, to enable the delivery of streaming data from a plurality of transmitting peer computers to a single recipient peer computer in a peer-to-peer environment.

In one embodiment of the invention, video is stored on the receiving participant unit (which, in one embodiment of the invention, is attached to a TV cable network). In another embodiment of the invention, the system is configured for the generic depiction of publication times (as opposed to the depiction of actual download times). This serves to further improve the practical use of the invention. In yet another embodiment of the invention, the system comprises a unit (such as a resource unit and/or a capacity plan unit) that is configured for optimizing the transfer of streamed data over the participant side upstream and downstream bandwidths, even when the bandwidths are asymmetrical.

As described above, one embodiment of the invention is a complete, streaming, optimized distribution system for both publishing and downloading streaming electronic documents. In one embodiment of the invention, the recipient computer requires server support (e.g., from a reconstruction unit) for decrypting the electronic document. The reconstruction unit may be configured for accessing electronic operating command data from a suitable server unit. Alternatively, this operating command data may be provided in the peer-to-peer system within the participant unit itself, or in any other suitable data repository.

First Exemplary Embodiment of the Invention

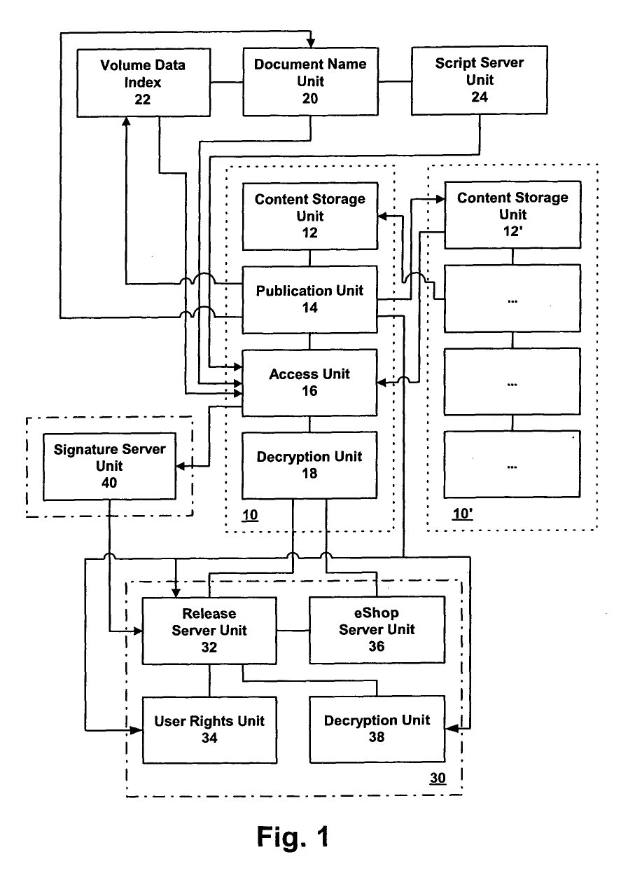

A first embodiment of the present invention, which is shown in FIG. 1, is an Internet-based peer-to-peer system for distributing electronic documents such as MP3 files. Although the functionality of the system is discussed below in regard to the transfer of MP3 files, it should be understood that this system may be used to transfer other types of electronic files such as video, text, or program files.

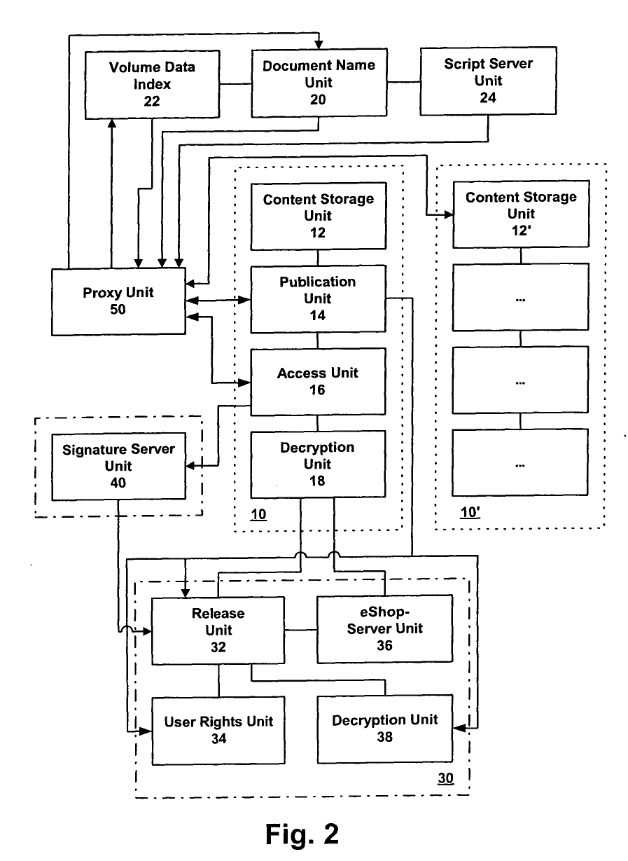

As may be understood from FIG. 1, this embodiment of the invention comprises a plurality of participant units 10, which may be, for example, personal computers (or servers) that are connected to the Internet. In one embodiment of the invention, each participant unit 10 comprises: a content storage unit 12, a publication unit 14, an access unit 16, and a decryption unit 18. As will be understood by one skilled in the art, the content storage unit 12, publication unit 14, access unit 16, and decryption unit 18 (as well as any of the other units and indexes shown in FIGS. 1 and 2 or discussed herein) may be embodied in the form of software, hardware, or a combination of software and hardware. In addition, various units may be configured for operation on a common hardware platform or on separate hardware platforms.

In one embodiment of the invention, the content storage unit 12 is configured for local (i.e., participant-side) deposit of MP3 documents, each being in the form of an arrangement of individual data segments that make up a particular MP3 document. More particularly, in one embodiment of the invention, the data segments are single MP3 frames or blocks of MP3 frames. The deposit of these data segments is done in an encrypted manner, so that the sequence of the MP3 data segments does not correspond to their original usable form. For example, in one embodiment of the invention, if the MP3 data were reproduced in the deposited (encrypted) form (e.g., by a reproduction unit associated with the participant unit 10), a disjointed and therefore unusable sound effect would result when playing the music. In one example, this unusable sound effect would correspond to the various MP3 frames that make up the MP3 document being played out of order, with gaps between the MP3 frames, and/or with unrelated MP3 frames being inserted between two or more of the MP3 frames that make up the MP3 document.

In a particular embodiment of the invention, the publication unit 14 is configured to enable the publication of copyright-protected documents stored on the server unit (e.g., MP3 music files) to one or more other participant units within the system. More particularly, the publication unit 14 is configured to divide an MP3 file to be published into a plurality of data segments and to form the data segments into an arrangement that does not correspond to the usable form of the file (i.e., the arrangement of the data segments within the original, unencrypted version of the file when the file is played).

For this purpose, the publication unit 14 comprises one or more units, not shown in FIG. 1, for performing a structural analysis of the MP3 data to be published. In addition, the publication unit 15 comprises one or more units for arranging the data segments that make up the MP3 data in a manner that provides an encryption effect (e.g., by rearranging the individual MP3 frames—or blocks of MP3 frames—that make up the MP3 data, or by inserting new MP3 frames between those frames or blocks of frames). Additionally, in one embodiment of the invention, the publication unit 14 is configured for depositing, on another participant unit 10′ connected to the Internet (e.g., on the participant unit's content storage unit 12′), the new arrangement of data segments generated by the publication unit 14. In addition, the publication unit 14 is also configured for depositing a part or all of the new arrangement of data segments generated by the publication unit 14 onto the participant unit's own content storage unit 12.

In one embodiment of the invention, in order to enable access by other participant units within the framework of the peer-to-peer system, the publication unit 14 simultaneously provides, to a volume data index 22, a title associated with the published music data to a document unit 20, and an address (e.g., storage location) associated with the published music data. (This title and address are both considered to be “identification data associated with the music data.”) Both the document unit 20 and the volume data index 22 are typically offered as network services and are provided on appropriate server units connected to the Internet. (As noted above, the document unit 20 and the volume data index 22 may be provided in the form of software executed on each participant unit 10).

Finally, the publication unit 14 makes the publication data available to a reconstruction unit 30. This publication data may include, for example, information about the reconstruction of the encrypted document (e.g., the correct succession of the data segments for enabling a correct playback of the MP3 documents), as well as further data relevant to the distribution of the encrypted document, such as possible user rights of third parties, or further conditions for access by third parties. The functionality of the publication unit 14 is described below in connection with the access and reproduction process.

As noted above, in one embodiment of the invention, the participant unit 10 includes an access unit 16 on the participant side of the system. This access unit 16 is configured for enabling the participant unit 10 to access, via the peer-to-peer network, data segments of electronic documents that are distributed among other participant units.

For this purpose, the access unit 16 is constructed to access the document name unit 20. As a result, the system is configured to allow a user to identify the desired musical piece by name, and to request, via a script server unit 24, a sequence of command data (script), which enables script-controlled access to: (1) the respective content storage units 12, 12′ of different participant units within the electronic data network according to the sequence given by the command data (script); and (2) the respective addresses stored in the volume data index 22. As a result of this access, a plurality of data segments of the desired musical piece are locally present in the participant unit 10, but in a form not suitable for playback (i.e. encrypted).

In one embodiment of the system shown in FIG. 1, a server-based signature server unit 40 is used to confirm (especially by means of a characteristic signature of a targeted musical piece) that the musical piece to be downloaded is actually associated with the respective MP3 data that is provided for distribution according to the invention. As shown in FIG. 1, in a particular embodiment of the invention, there is an additional connection between the signature server unit 40 and the reconstruction unit 30.

In another embodiment of the invention, the participant unit 10 (or an additional participant unit) is configured to determine, based on a document signature present on the publisher or author side, whether a respective document that is intended for publication possesses the required publisher or author distribution rights (in this case there is also a connection to the publication unit 14).

As noted above, in one embodiment of the invention, each participant unit 10 includes a decryption unit 18. This decryption unit 18 serves to decrypt (e.g., reconstruct) the plurality of data segments of the desired MP3 music data downloaded from the network by means of an access unit 16 and thus bring the MP3 music data into a usable form. In one embodiment of the invention, this is only made possible through contact with the reconstruction unit 30, through which the participant unit's decryption unit 18 initiates this reconstruction (e.g., decryption) process.

In one embodiment of the invention, the reconstruction unit 30 comprises a release server unit 32 that is configured to determine, by means of an ancillary user rights unit 34 as well as a connected eShop server unit 36, whether the respective participant accessing it by means of a decryption unit 18 has the right to access (and decrypt) a music file (e.g., by determining whether a user associated with the participant has made a payment required to access the file).

In a particular embodiment of the invention, it is possible to obtain the right to play back a decrypted musical piece (e.g., from the participant side) from the reconstruction unit 30 (or the eShop server unit 36) by taking certain specified steps (such as making a specified payment to a particular entity). A decryption unit 38 then enables the release unit 32 to transmit the reconstruction data for generating a decrypted form of the electronic document (e.g., MP3 music data) that is usable for playback when the reconstruction data are used by the decryption unit 16, in the manner described herein, to bring the data segments present on the participant side into a useful order suitable for playback. In one embodiment of the invention, in order to prevent subsequent misuse of the downloaded music data, the electronic document is regenerated locally on the participant side in a form that provides the participant no opportunity to store the reconstructed, usable music data in a usable form.

As will be understood by one skilled in the art, the present invention is not limited to embodiment of the invention described in FIG. 1. For example, the present invention may be embodied in other forms that, for example, include additional components for implementing the functionality of the volume data index, the document name unit, or the script server unit in a client/server based arrangement, or for implementing this functionality in a distributed manner over a network.

Second Exemplary Embodiment of the Invention

FIG. 2 illustrates a further embodiment of the invention in which the participant unit 10 comprises a proxy unit 50. As can be seen from FIG. 2, the proxy unit 50 acts as a dedicated unit for executing certain functionality on behalf of the participant unit 10. More particularly, in one embodiment of the invention, the proxy unit 50 is configured for executing the functions of the publication unit 14 and the access unit 16 described above. In addition, the proxy unit 50 may be configured for coordinating and executing contact on the publication side with the volume data index 22 and the document name unit 20, as well as the content storage units 12′ of one or more other participants. On the download side, the proxy unit 50 may be configured to establish a connection between the participant unit's access unit 16 and the script server unit 24, and to coordinate script-controlled (e.g., control data controlled) downloads from the content storage units 12′ of other participant units that are distributed within the network.

In a particular embodiment of the invention, providing a participant unit 10 with a proxy unit 50 serves to reduce the number of processing tasks performed by the participant unit and to establish an independent unit for accessing other computers within the peer-to-peer network.

Systems according to various embodiments of the present invention provide many advantages over prior art data distribution systems. For example, in one embodiment of the invention, the system prevents unauthorized publication or use of an electronic document by requiring at least one (e.g., temporary) access to a central (preferably server-based) reconstruction unit (or release server unit) before each access of a particular document. In a particular embodiment of the invention, if content-manipulated or forged electronic documents are published over the network, any use of the content can be interrupted as soon as recognized by sending a corresponding, normally automated, notification to the script server unit (e.g., script generating unit). In response to receiving this notification, the script server unit prevents future access to the document.

In one embodiment of the invention, the data segments associated with each document download by a participant unit for local use are also available for further distribution or access by third parties.

Also, in a particular embodiment of the invention, the content (i.e., the respective electronic documents) are located in the respective content storage unit of each participant unit in encrypted form and are thus copy protected.

In regard to communication errors in the network or the breakdown of individual junctions within the network, a system according to one embodiment of the invention has the advantages associated with a peer-to-peer network. More particularly, a respective needed data segment can be downloaded by any of a plurality of alternative participant units if a connection to a particular participant unit is lost during a download.

Another advantage associated with a particular embodiment of the invention regarding preventing copyright violations and misuse of electronic files is due to the fact that, in this embodiment of the invention, user-specific (and thus identifying) encryption variations exist for an electronic document due to the fact that the arrangement of the data segments is unique to the particular user. Thus, if the data segments are transmitted to another user without authorization, the source of the data segments can be identified by comparing a respective version with the corresponding script (e.g., the individual operating sequence command data) provided to the participant.

In order to encourage continued use of a system according to one embodiment of the invention, the system is associated with a reward program. This reward program is preferably set up to encourage participants to remain active and online as a participant of the distribution network and, accordingly, remain available for downloads to other participants in the peer-to-peer network. It should be noted that, due to the inherent asymmetry between the upload and download channels of most high-speed Internet connections, participants are motivated to remain active due to the fact that downloading through a participant unit (and the speed thus achieved) is limited by the typically slower upload channel of the respective partner participant unit and the simultaneous loading of several participants is desirable.

According to further embodiments of the invention, it is useful to provide the document name unit 20 of FIG. 1 in the form of a directory, perhaps with overlapping sources. This makes it possible to provide specialized themes, perhaps through corresponding metadata. It is also possible, as discussed above, to decentralize such content indices. A content search could then be done in a cascading way, for example as done by the existing Gnutella system.

One embodiment of the invention comprises multiple (e.g., redundant) script server units. In this embodiment, the failure of one script server unit will not significantly impact the system's performance because other script server units remain available to facilitate the transfer of documents within the system. This central (e.g., distributed) script generating functionality is especially suitable for use in offering certain content for certain territories (e.g., certain Internet offers).

An additional embodiment of the invention is configured for providing information regarding the segmentation of a document into data segments (such as references to possible reconstruction data) within the document itself. Such information may be provided, for example, within the document's so-called ID3 record of an MP3 file. A further embodiment of the invention is configured for depositing the address of an associated reconstruction server within a document.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A system for distributing electronic documents, said system comprising:
a first computer;
a second computer;
a third computer; and
a network over which information may be transferred from said second and third computers to said first computer, wherein said first computer is configured for:
receiving operating sequence command data;
accessing an electronic document over said network by downloading, via at least two separate downloads, a plurality of data segments that are associated with an electronic document and that represent an encrypted form of said electronic document, at least one of said downloads being from said second computer and at least one of said downloads being from said third computer, said electronic document being encrypted by the effect of said operating sequence command data determining the order of said data segments, said plurality of data segments not being usable by a user as downloaded;
accessing reconstruction data over said network; and
using said reconstruction data and said encrypted form of said electronic document to make said electronic document available for use in a suitable decrypted form.

2. The system of claim 1, wherein:
said first computer is associated with a first user;
said second computer is associated with a second user; and
said third computer is associated with a third user.

3. The system of claim 1, wherein said first, second, and third computers are participant units.

4. The system of claim 1, wherein said operating sequence command data is user-specific.

5. The system of claim 1, wherein said operating sequence command data is document-specific.

6. The system of claim 1, wherein said first computer is configured for receiving said operating sequence command data from a command data unit connected to said network.

7. The system of claim 1, further comprising a reconstruction unit that is configured for storing said reconstruction data in an encrypted form.

8. The system of claim 7, wherein said reconstruction unit is associated with a user identification unit that is configured for gathering user specific data.

9. The system of claim 7, wherein said reconstruction unit is associated with a billing unit that is configured for executing a financial transaction with said first user in response to said first computer accessing said reconstruction data.

10. The system of claim 1, wherein said first computer comprises a decryption unit that is configured for:
accessing said reconstruction data over said network; and
using said reconstruction data and said encrypted form of said electronic document to make said electronic document available for use in a suitable decrypted form.

11. The system of claim 1, wherein said system is configured so that said electronic document cannot be stored on said first computer in a decrypted form.

12. The system of claim 1, wherein said data segments are arranged in a hierarchical form as at least a first and a second group of data segments, said first group of data segments being configured to be downloaded via said at least two downloads in accordance with said operating sequence command data, and said second group of data segments being configured to be reconstructed in accordance with said reconstruction data.

13. The system of claim 12, wherein said reconstruction data is associated with said first group of data segments.

14. The system of claim 13, wherein said reconstruction data is dynamically generated during said at least two downloads.

15. A peer-to-peer system for distributing electronic documents, said system comprising:
a first peer computer that is associated with a first user; and
a network over which information may be transferred from said first peer computer to a second peer computer that is associated with a second user, wherein said first peer computer is configured for:
dividing an electronic document into a plurality of data segments;
producing an encrypted form of said electronic document that is encrypted via an arrangement of said data segments, said arrangement being determined by a set of operating sequence command data;
transmitting said plurality of data segments to said second peer computer; and
generating a set of data that is useable for generating said set of operating sequence command data.

16. The peer-to-peer system of claim 15, wherein said first peer computer is configured for transmitting said set of data to a third computer within said peer-to-peer system.

17. The peer-to-peer system of claim 15, wherein:
said electronic document is a first electronic document;
said plurality of data segments is a first plurality of data segments;
said set of data is a first set of data;
said set of operating sequence command data is a first set of operating sequence command data; and
said second peer computer is configured for:
dividing a second electronic document into a second plurality of data segments;
producing an encrypted form of said second electronic document that is encrypted via an arrangement of said second plurality of data segments, said arrangement of said second plurality of data segments being determined by a second set of operating sequence command data;
transmitting said second plurality data segments to said first peer computer; and
generating a second set of data that is useable for generating said second set of operating sequence command data.

18. The system of claim 17, wherein said second peer computer is configured to transmit said second plurality of data segments to said first peer computer while receiving said first plurality of data segments from said first peer computer.

19. The system of claim 17, wherein said second peer computer is configured to transmit said second plurality data segments to said first peer computer over a first bandwidth while receiving said first plurality of data segments from said first peer computer over a second bandwidth.

20. The peer-to-peer system of claim 15, wherein said first peer computer is configured to determine whether distribution of said electronic document is authorized and, in response to determining that distribution of said electronic document is not authorized, preventing transmission of said plurality of data segments to said second peer computer.

21. The peer-to-peer system of claim 15, wherein said step of producing an encrypted form of said electronic document comprises reordering two or more of said plurality of data segments.

22. The peer-to-peer system of claim 15, wherein said step of producing an encrypted form of said electronic document comprises inserting one or more extra data segments into said plurality of data segments.

23. The peer-to-peer system of claim 15, wherein said step of producing an encrypted form of said electronic document comprises removing at least one of said plurality of data segments from said plurality of data segments.

24. The peer-to-peer system of claim 15, wherein said step of producing an encrypted form of said electronic document comprises substituting at least one of said plurality of data segments with another data segment.

25. The peer-to-peer system of claim 15, wherein said first peer computer is configured to use information about exchanged, removed, added or substituted data segments to generate reconstruction data.

26. The peer-to-peer system of claim 15, wherein said first peer computer is configured to determine whether said electronic document has been encrypted by virtue of one or more of said data segments being removed or replaced.

27. The peer-to-peer system of claim 15, wherein said electronic document is an audio, video, or animation file.

28. The peer-to-peer system of claim 15, wherein said electronic document comprises program data.

29. A method of distributing electronic documents, said method comprising the steps of:
receiving a request for an electronic document from a first peer computer connected to a network;
identifying a plurality of data network addresses, each of said plurality of data network addresses corresponding to a location of at least one of a plurality of data segments associated with said electronic document, said plurality of data segments being stored, in a distributed manner, on a plurality of peer computers;
providing an operating sequence command set that comprises said plurality of data network addresses; and
transmitting said operating sequence command set to said first peer computer so that said first peer computer may use said operating sequence command set to access at least one of said plurality of data segments.

30. The method of claim 29, wherein said first peer computer is configured to use said operating sequence command set to store said plurality of data segments in a predetermined sequence.

31. The method of claim 30, wherein said predetermined sequence is customized to said first peer computer.

32. A method of distributing electronic documents, said method comprising the steps of:
receiving operating sequence command data;
accessing an electronic document over a network by downloading, via one or more downloads from each of a plurality of computers, a plurality of data segments that are associated with an electronic document and that represent an encrypted form of said electronic document, said electronic document being encrypted by the effect of said operating sequence command data determining their order, said plurality of data segments not being usable by a user as downloaded;
accessing reconstruction data over said network; and
using said reconstruction data and said encrypted form of said electronic document to make said electronic document available for use in a suitable decrypted form.

33. A system for distributing electronic documents within a peer to peer network, said system comprising:
a first peer computer associated with a first user;
a second peer computer associated with a second user; and
a data server unit, wherein:
said first peer computer is configured for dividing an electronic document into two or more data segments, said two or more data segments being associated with at least one correct playback sequence;
said data server unit is configured for generating an encryption sequence for said two or more data segments, said encryption sequence being different than said correct playback sequence; and
said second peer computer is configured for: (a) receiving at least one of said data segments from said first computer, and (b) storing said at least one data segment in a file that corresponds to an encrypted form of said electronic document in which the data segments that comprise said electronic document are stored in said encryption sequence.

34. The system of claim 33, wherein:
said second peer computer is configured for dividing said electronic document into two or more data segments, said two or more data segments being associated with said at least one correct playback sequence; and
said first peer computer is configured for: (a) receiving at least one of said data segments from said second computer, and (b) storing said at least one data segment in a file that corresponds to an encrypted form of said electronic document in which the data segments that comprise said electronic document are stored in said encryption sequence.

35. The system of claim 34, wherein:
said system comprises a third computer;
said third computer is configured for dividing said electronic document into two or more data segments, said two or more data segments being associated with said at least one correct playback sequence; and
said third computer is configured for: (a) receiving at least one of said data segments from said second computer, and (b) storing said at least one data segment in a file that corresponds to an encrypted form of said electronic document in which the data segments that comprise said electronic document are stored in said encryption sequence.

36. A system for distributing electronic documents of a predetermined document data structure in a publicly accessible electronic data network, said system comprising:
a plurality of participant units that are connected to the electronic data network at least part of the time, each of the participant units being associated with a user and being constructed for executing a download of an electronic document by a participant unit or a server unit connected to the data network as well as for opening the electronic document by means of a playback unit, and wherein:
the participant units are constructed for accessing the electronic document over the publicly accessible electronic data network in such a way that multiple downloads of a plurality of associated data segments are executed, where at least one download is done by another participant unit that is associated with another user;
the participant units receive document and/or participant specific operating sequence command data from a command data unit connected to the electronic data network;
the plurality of electronic data segments are available to the participant through a plurality of downloads, are associated with the electronic document, and represent the form of the electronic document, the electronic document being encrypted by the effect of the operating sequence command data determining the order of the electronic data segments, which are not usable by the user in the way provided;
a reconstruction unit is connected to the electronic data network, the reconstruction unit being configured for storing reconstruction data related to an electronic document in an encrypted form; and
each of the participant units comprises a local decryption unit that is designed for at least one access to the reconstruction unit for each electronic document over the electronic data network and to bring together the encrypted form for making said electronic document available for use in a suitable decrypted form.

37. The system of claim 36, wherein the participant units are configured so that the electronic document cannot be stored on a participant side in the decrypted form.

38. The system of claim 36, further comprising a user identification unit that is associated with the reconstruction unit and that is configured for gathering user specific data.

39. The system of claim 36, further comprising a user identification unit that is associated with the reconstruction unit and that is configured for assigning or managing user or user group specific access rights.

40. The system of claim 36, further comprising a billing unit that is associated with the reconstruction unit and that is configured for executing a financial transaction with the user.

41. The system of claim 36, further comprising a proxy unit that is connected to the electronic data network, and that is configured for:
receiving the operating sequence command data; and
executing a plurality of downloads on behalf of a respective participant unit.

42. The system of claim 36, wherein each of the participant units comprises a publication unit that is configured for:
dividing the electronic document into a plurality of data segments;
producing a distributable version of the electronic document, the distributable version being encrypted via the arrangement of the data segments, and the arrangement of data segments being determined by operating sequence command data;
transmitting the plurality of electronic data segments to at least one other participant unit; and
recording document-specific data on a document name unit that is connected to the electronic data network and that comprises a data server unit that is connected to the electronic data network and that is configured for storing data about one or more data segments stored on at least one other participant unit, said data being used to generate operating sequence commands.

43. A system for distribution of electronic documents of a predetermined data structure in a publicly accessible electronic data network, said system comprising:
a plurality of participant units connected to the electronic data network at least part of the time, each of said participant units being:
associated with a user,
configured for executing a download of an electronic document from a participant unit connected to the electronic data network or from a server unit, and
configured for opening the electronic document by means of a user-side playback unit, wherein each of said participant units comprises a publication unit that is configured for:
dividing the electronic document into a plurality of data segments;
producing a distributable version of the electronic document, the distributable version being encrypted via the arrangement of the data segments, and the arrangement of data segments being determined by operating sequence command data;
transmitting the plurality of electronic data segments to at least one other participant unit; and
recording document-specific data on a document name unit that is connected to the electronic data network and that comprises a data server unit that is connected to the electronic data network and that is configured for storing data about one or more data segments stored on at least one other participant unit, said data being used to generate operating sequence commands.

44. The system according to claim 43, further comprising a script generating unit that operates together with the data server unit, and that is configured for generating the operating sequence command data.

45. The system of claim 44, wherein the script generating unit is a script server unit or a part of the participant unit.

46. The system of claim 43, wherein:
the publication unit comprises an identification and/or verification unit for distributing the document, and
the publication unit is configured for:
performing signature-based screening on a document to be distributed for user-side authorization,
in response to an outcome of the authorization screening, preventing the generating, distribution, transmission and/or deposit of the screened document; and
comparing document-specific identification data with identification data received from an identification server unit connected to the electronic data network.

47. The system of claim 43, wherein the system is configured to:
generate the encrypted form of the electronic document by means of an encryption unit as part of the publication unit and/or to generate the electronic document in a decrypted form by means of the local decryption unit performing the following operations on the data segments of the document data structure of the electronic document:
exchanging and/or removal of a data segment, and/or
addition of a data segment to a predetermined position in a series of data segments, and/or
substituting a data segment with a data segment preferably not contained in the original electronic document.

48. The system of claim 47, wherein said operations are performed by means of computer access to electronic storage areas of an electronic encryption unit associated with the data segments of the document data structure.

49. The system of claim 47, wherein said operations are performed by means of computer access to electronic storage areas of a local decryption unit electronic encryption unit associated with the data segments of the document data structure.

50. The system of claim 47, wherein the electronic encryption unit is designed for generating reconstruction data with information about the exchanged, removed added and/or substituted data segments.

51. The system of claim 47, further comprising format recognition means associated with the participant unit, the format recognition means being configured for:
enabling the user to determine whether an electronic document was encrypted by exchanging, removal, addition and/or substitution of data segments, and
extracting an address of at least one of the data segments for access to the reconstruction data.

52. The system of claim 47, wherein the electronic document is selected from a group comprising: audio data, video data, animation data, simulation data and program data.

53. The system of claim 47, wherein the data format of the electronic document is selected from a group consisting of: MP3, MPEG, and XML.

54. The system of claim 47, wherein:
the electronic data segments are present in hierarchy form as at least a first and a second group of data segments,
the first group of data segments is configured for being downloaded, via the plurality of downloads, by means of the electronic operating sequence command data; and
the second group of data segments is subordinate to the first group of data segments and is designed for being reconstructed by means of assigned reconstruction data.

55. The system of claim 54, wherein the reconstruction data is associated with the first group of data segments.

56. The system of claim 55, wherein the reconstruction data is dynamically generated during a plurality of downloads.

57. The system of claim 56, wherein the electronic document comprises an audio or video stream and the command data unit and the participant unit are configured so that two or more of the plurality of downloads can occur simultaneously.

58. The system of claim 57, wherein the plurality of downloads are completed by a plurality of participant units.

59. The system of claim 58, wherein:
the operating sequence command data unit is configured for generating the operating sequence command data; and
the participant unit is configured to simultaneously send and receive electronic data segments.

60. The system of claim 59, wherein the operating sequence command data unit is configured so that during simultaneous sending and receiving of the electronic data segments, a different bandwidth for the sending and receiving operations is utilized.

61. A method of distributing copyright-protected electronic documents of a predetermined document data structure in a publicly accessible electronic data network, comprising the steps of:
receiving an inquiry for an electronic document from a participant unit connected to the electronic data network;
identifying a plurality of addresses that correspond to the storage locations of a plurality of data segments that are associated with the electronic document, the data segments being stored on a plurality of participant units in a distributed manner;
providing an operating sequence command set that contains the addresses in a predetermined sequence;
transmitting the operating sequence command set to the participant unit; and
using the operating sequence command set to access the plurality of data segments for purposes of storing the plurality of data segments on a participant-side in the predetermined sequence.

62. The method of claim 61, wherein the predetermined sequence is provided individually and in an identifying way for the participant unit transmitting the inquiry.
